(19) United States
(12) Patent Application Publication
(10) Pub. No.: US 2019/0074761 A1
(43) Pub. Date: Mar. 7, 2019

(54) SEMICONDUCTOR DEVICE FOR POWER SUPPLY CONTROL AND POWER SUPPLY DEVICE, AND DISCHARGING METHOD FOR X CAPACITOR

(71) Applicant: Hiroki MATSUDA, Zama-shi (JP)

(72) Inventor: Hiroki MATSUDA, Zama-shi (JP)

(73) Assignee: MITSUMI ELECTRIC CO., LTD., Tokyo (JP)

(21) Appl. No.: 16/118,801

(22) Filed: Aug. 31, 2018

(30) Foreign Application Priority Data
Sep. 1, 2017 (JP) 2017-168344

(51) Int. Cl. H02M 1/32; H02M 3/335; H02M 1/08

(52) U.S. Cl. CPC H02M 1/32; H02M 3/33507; H02M 2001/0032; H02M 2001/322; H02M 1/08

(57) ABSTRACT

A semiconductor device for power supply control generating and outputting a driving pulse for performing control to turn on/off a switching element by inputting voltage in proportion to current in the primary-side winding wire and an output voltage detection signal from a secondary side, the device including: a high-voltage input start terminal to which alternating-current voltage of AC input or rectified voltage is input; voltage comparison circuits to which voltage obtained by dividing voltage input to the high-voltage input start terminal is input and which compare the input voltage with any of reference voltages; a timer circuit which starts to measure a predetermined time at a timing of rising and/or falling of output of the voltage comparison circuits; and a discharging unit between the high-voltage input start terminal and a ground point, wherein the discharging unit is made conductive when the predetermined time is measured.

### BACKGROUND OF THE INVENTION

### 1. Field of the Invention

The present invention relates to a semiconductor device for power supply control, and particularly to a technique which is effectively used in a semiconductor device for primary-side control that is included in an insulated direct-current power supply device provided with a transformer for voltage conversion.

### 2. Description of Related Art

Examples of direct-current power supply devices include an insulated AC-DC converter which is structured by, for example, a diode bridge circuit that rectifies an alternating-current power supply, a DC-DC converter that reduces the direct-current voltage rectified in the diode bridge circuit to convert the voltage into a direct-current voltage of a desired potential and the like.

In a general insulated AC-DC converter, an X capacitor is connected between AC terminals in order to attenuate the normal-mode noise and a resistor for discharging is connected in parallel with the X capacitor in order to promptly discharge the residual charges in the X capacitor when a plug is pulled out of an outlet.

The AC-DC converter including the resistor for discharging which is connected in parallel with the X capacitor, however, always consumes power during the connection to the AC power supply. Therefore, the standby power consumption at the time of load not being applied and at the time of standby is increased.

Thus, in order to reduce the power consumption during the standby, there have been suggested inventions each provided with an X capacitor discharging circuit that can promptly discharge the residual charges in the X capacitor when the plug is pulled out (for example, see Japanese Patent No. 5664654, and Japanese Patent Application Laid Open Publication Nos. 2016-158310 and 2016-158399).

Some of computer peripheral equipment and home appliances like a printer are used in a manner that a power switch is turned on only when it is used and the power switch is turned off in a state in which a cord is still plugged in after it was used. Since an AC-DC converter as a power supply device incorporated in such electronic equipment does not stop its operation as long as the cord is plugged in, there is a problem that the power consumption during standby is large. It is known that the standby power consumption of the AC-DC converter has an extremely high proportion of current consumption of the primary-side control IC.

In the X capacitor discharging circuit, in a case where an AC input voltage is supplied from a power plug, the AC input state needs to be constantly monitored regardless of the state of device (for example, off mode of ultralow consumption). Thus, in order to reduce the power consumption of the device, it is necessary to reduce the consumption of the X capacitor discharging circuit part (detection of the AC input state). When an AC plug is pulled out in a state of non-load of power supply or in a state of a light load close to the non-load, electric charges remain in a capacitor connected to the input circuit of the power supply. Thus, the voltage remains between both terminals of the AC plug for a while. In order to prevent the electric shock by this residual voltage in this plug, the residual voltage after a defined period elapsed from removal (pulling) of the AC plug is defined by Electrical Appliance and Material Safety Law or a safety standard such as IEC60950.

The inventions described in Japanese Patent No. 5664654 and Japanese Patent Application Laid Open Publication No. 2016-158310 are configured so that a peak holding circuit which holds a peak voltage of the AC input voltage, a voltage comparison circuit and a timer circuit are provided as a circuit for detecting the removal of the plug, and that, in a case where the AC input voltage continues to be not lower than a predetermined voltage for a predetermined time period, the plug is determined to be pulled out and the discharging unit (switch) is turned on to discharge the residual charges in the X capacitor.

Since the AC-DC converter having such a detection circuit determines that the AC input voltage is decreased by using a rate to the peak, it is possible to detect removal of the plug even when the amount of AC input voltage is changed. That is, there is an advantage of providing a worldwide semiconductor device for power supply control. However, there is a problem that the power consumption is large since the number of circuits is large, and the chip size is increased since elements having large occupying areas such as capacity of the peak holding circuit and a diode are used.

A standby mode for reducing power consumption is provided to some of primary-side control ICs in conventional AC-DC converters (for example, see Japanese Patent Application Laid Open Publication No. 2016-158399). However, in the invention described in Japanese Patent Application Laid Open Publication No. 2016-158399, there is a problem that the power consumption during standby is not sufficiently reduced due to operations of the internal power supply circuit, the circuit for starting the IC, the circuit for controlling the starting, the discharging circuit of the X capacitor, the reference voltage circuit and the bias circuit in the standby mode. However, if operation of the discharging circuit for the X capacitor is stopped in the standby mode in order to reduce the power consumption, there is a problem that it is not possible to detect the removal of the plug to perform discharging of the X capacitor in the standby mode.

The present invention has been made in view of the problems as described above, and an object of the present invention is to reduce the circuit scale of the circuit which performs discharging of the X capacitor and to reduce the power consumption and the chip size in the semiconductor device for control forming the insulated direct-current power supply device.

Another object of the present invention is to provide a semiconductor device for power supply control which can reduce the power consumption during standby and detect removal of the plug and promptly discharge the residual charges in the X capacitor when the plug is removed even during the standby.

### SUMMARY OF THE INVENTION

In order to achieve at least one of the above objects, according to one aspect of the present invention, there is provided a semiconductor device for power supply control which generates and outputs a driving pulse for performing control to turn on or off a switching element which intermittently makes current flow to a primary-side winding wire of a transformer for voltage conversion, by inputting voltage in proportion to current flowing in the primary-side winding wire of the transformer and an output voltage detection signal from a secondary side of the transformer, the semiconductor device including: a high-voltage input start terminal to which alternating-current voltage of AC input or voltage rectified in a diode bridge is input; a plurality of voltage comparison circuits to which voltage obtained by dividing voltage input to the high-voltage input start terminal is input, and which compare the input voltage with any of a plurality of reference voltages that are different from each other; a timer circuit which starts to measure a predetermined time at a timing of rising and/or falling of output of the plurality of voltage comparison circuits; and a discharging unit which is provided between the high-voltage input start terminal and a ground point, wherein when the timer circuit measures the predetermined time, the discharging unit is made conductive.

According to the above configuration, it is possible to reduce the power consumption during the standby since the discharging unit is made conductive and the residual charges in the X capacitor is promptly discharged into the IC when the plug is removed from the outlet and the AC input is interrupted, and it is not necessary to connect the resistor for discharging in parallel with the X capacitor. Since the peak holding circuit which holds the peak value is not used and the AC input state is determined by the voltage comparison circuits, it is possible to reduce the circuit scale of the circuit which detects the timing of discharging of the X capacitor and to reduce the power consumption and chip size. Furthermore, since the circuit which monitors the voltage of the high-voltage input start terminal includes a plurality of voltage comparison circuits, it is possible to achieve a worldwide semiconductor device for power supply control.

Preferably, there are included a high-voltage switching element which is connected to the high-voltage input start terminal; a first power supply terminal to which voltage induced by an auxiliary winding wire of the transformer is input; a second power supply terminal to which a receiving element that receives a command signal from outside is connected; a command input terminal to which a current-voltage converting unit that is connected in series with the receiving element and converts current flowing in the receiving element into voltage is connected; a first power supply line and a first switching unit which is provided on the first power supply line, the first power supply line being connected between the high-voltage input start terminal and the first power supply terminal via the high-voltage switching element; a second power supply line and a second switching unit which is provided on the second power supply line, the second power supply line being connected between the high-voltage input start terminal and the second power supply terminal via the high-voltage switching element; a Zener diode which is connected between the second power supply line and the ground point; a bias circuit which is connected to the second power supply line; and a detection circuit which is connected to the bias circuit and compares voltage of the command input terminal with a predetermined voltage value to detect whether input is performed or not, and under a predetermined condition, the first switching unit is turned on and the second witching unit is turned off when the detection circuit detects that the voltage of the command input terminal is lower than the predetermined voltage value, and the first switching unit is turned off and the second witching unit is turned on when the detection circuit detects that the voltage of the command input terminal is higher than the predetermined voltage value.

By such a configuration, the first switching unit is turned off and the second switching unit is turned on when the detection circuit detects that the voltage of command input terminal is higher than a predetermined voltage value by a command signal from outside. Thus, the internal power supply circuit is stopped, current is supplied to the Zener diode via the high-voltage switching element and the second switching unit, to function as a power supply unit, and thereby the detection circuit and the bias circuit connected to the second power supply line can be operated. Thus, it is possible to shift to the off mode of operating only the minimum circuit which is needed, and it is possible to largely reduce the power consumption during the standby.

Preferably, there are included an internal power supply circuit which is connected to the first power supply line; a third switching unit which is provided between the Zener diode and the second power supply terminal; and a fourth switching unit for supplying an internal voltage generated by the internal power supply circuit to the second power supply line, and the third switching unit is turned off and the fourth switching unit is turned on when the detection circuit detects that the voltage of the command input terminal is lower than the predetermined voltage value, and the third switching unit is turned on and the fourth witching unit is turned off when the detection circuit detects that the voltage of the command input terminal is higher than the predetermined voltage value.

By such a configuration, since the bias circuit and the detection circuit are operated by the power supply voltage generated in the Zener diode in the off mode, it is possible to stop all of the reference voltage circuit, the internal power supply circuit, the bias circuit and the like for operating all the IC circuit blocks which are necessary in the normal operation mode. Thus, it is possible to largely reduce the power consumption in the off mode.

Preferably, operation of the internal power supply circuit is stopped based on an output signal of the detection circuit when the detection circuit detects that the voltage of the command input terminal is higher than the predetermined voltage value.

By such a configuration, it is possible to stop the operation of the internal power supply circuit more promptly when shifting to the off mode in a case where the internal power supply circuit is connected to the first power supply terminal (VDD1) to which the voltage from the auxiliary power supply circuit connected to the auxiliary winding wire of the transformer is applied.

Preferably, a fourth switching unit is formed by a field effect transistor, and a back gate control circuit is provided so as to correspond to the fourth switching unit, the back gate control circuit being for preventing reverse current flow from the second power supply terminal to an internal power supply circuit on a third power supply line when Zener voltage is higher than an internal voltage.

By such a configuration, it is possible to prevent the current flow in the reverse direction through the parasitic diode of the field effect transistor as the fourth switching unit. Thus, it is possible to reduce the unnecessary power consumption.

It is possible to reduce the circuit scale of the circuit which performs discharging of the X capacitor and reduce the power consumption and chip size in the semiconductor device for control (primary-side control IC) included in the insulated direct-current power supply device which includes a transformer for voltage conversion and controls the output by turning on and off the current flowing in the primary-side winding wire. There is also an effect of providing a semiconductor device for power supply control including a circuit configuration which can reduce the power consumption in the off mode and promptly discharge the residual charges in the X capacitor surely even under the ultra-low power consumption state such as in the off mode.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a circuit configuration view showing an embodiment of an AC-DC converter as an insulated direct-current power supply device according to the present invention;

FIG. 2 is a block diagram showing a configuration example of a primary-side switching power supply control circuit (power supply control IC) of a transformer in the AC-DC converter in FIG. 1;

FIG. 3 is a waveform diagram showing the manner in which the voltage of each section is changed in the power supply control IC in the embodiment;

FIG. 4 is a characteristic view showing the relationship between the switching frequency and the feedback voltage VFB in the power supply control IC in the embodiment;

FIGS. 5A and 5B are a circuit configuration view showing one example of a discharging circuit in the power supply control IC in the embodiment and a modification example thereof;

FIGS. 6A to 6G are timing charts showing the operation timings when discharging is performed by the discharging circuit in FIG. 5 in a case where the power supply control IC in the embodiment is used for the power supply device of AV100V type;

FIGS. 7A to 7G are timing charts showing the operation timings when discharging is performed by the discharging circuit in FIG. 5 in a case where the power supply control IC in the embodiment is used for the power supply device of AV230V type;

FIG. 8 is timing charts showing the operation timings when discharging is performed by the discharging circuit in one example;

FIG. 9 is timing charts showing the operation timings of the configuration in which reset is performed at both of the timings of raising edge and lowering edge of input in the discharging circuit in one example;

FIG. 10 is a circuit configuration view showing a second example of the discharging control circuit;

FIG. 11 is a circuit configuration view showing a third example of the discharging control circuit; and

FIG. 12 is a circuit configuration view showing a configuration example of main parts in a power supply control IC of a second embodiment in a case where the discharging control circuit in FIG. 10 is used.

### DETAILED DESCRIPTION OF THE PREFERRED EMBODIMENT

Hereinafter, an embodiment of the present invention will be described in detail with reference to the drawings.

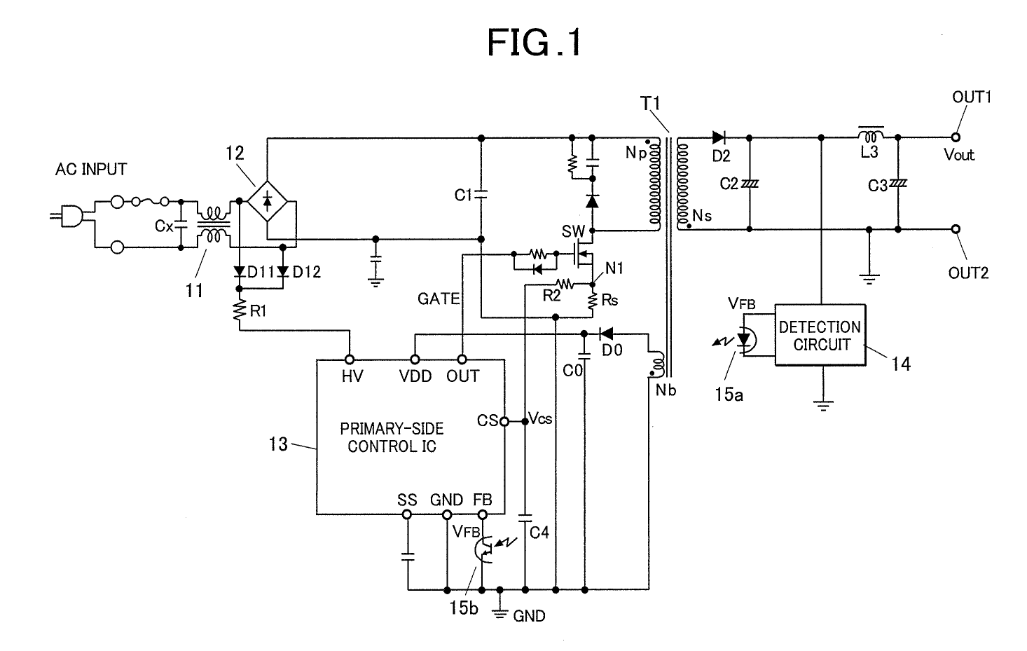

FIG. 1 is a circuit configuration view showing an embodiment of the AC-DC converter as an insulated direct-current power supply device to which the present invention is applied.

The AC-DC converter according to this embodiment includes: an X capacitor Cx connected between AC terminals for attenuating the normal-mode noise; a noise blocking filter 11 including a common-mode coil and the like; a diode bridge circuit 12 that rectifies alternating-current voltage (AC) and converts it into direct-current voltage; a smoothing capacitor C1 that smooths the rectified voltage; a transformer T1 for voltage conversion including a primary-side winding wire Np, a secondary-side winding wire Ns, and an auxiliary winding wire Nb; a switching transistor SW including an N-channel MOSFET connected in series with the primary-side winding wire Np of this transformer T1; and a power supply control circuit 13 that drives the switching transistor SW. In this embodiment, the power supply control circuit 13 is formed as a semiconductor integrated circuit (hereinafter referred to as a power supply control IC) on a single semiconductor chip formed of single-crystal silicon or the like.

On the secondary side of the transformer T1, a rectifying diode D2 connected in series with the secondary-side winding wire Ns and a smoothing capacitor C2 connected between a cathode terminal of this diode D2 and the other terminal of the secondary-side winding wire Ns are provided. By supplying current intermittently to the primary-side winding wire Np, the alternating-current voltage is induced by the secondary-side winding wire Ns, and by rectifying and smoothing this induced alternating-current voltage, the direct-current voltage Vout in accordance with the winding wire ratio between the primary-side winding wire Np and the secondary-side winding wire Ns is output.

In addition, a coil L3 and a capacitor C3 are provided on the secondary side of the transformer T1. The coil L3 and the capacitor C3 form a filter for blocking the switching ripple noise and the like occurring in the switching operation on the primary side. Moreover, on the secondary side of the transformer T1, there are provided a detection circuit 14 for detecting the output voltage Vout and a photodiode 15a as a light emission-side element of a photocoupler which is connected to the detection circuit 14 and transmits a signal corresponding to the detected voltage to the power supply control IC 13. Then, on the primary side, a phototransistor 15b is provided as a light reception-side element. The phototransistor 15b is connected between a ground point and a feedback terminal FB of the power supply control IC 13 and receives a signal from the detection circuit 14.

On the primary side of the AC-DC converter according to this embodiment, a rectifying/smoothing circuit is provided. The rectifying/smoothing circuit includes a rectifying diode DO connected in series with the auxiliary winding wire Nb, and a smoothing capacitor C0 connected between the ground point GND and a cathode terminal of the diode DO. The voltage rectified and smoothed in the rectifying/smoothing circuit is applied to a power supply terminal VDD of the power supply control IC 13.

On the other hand, the power supply control IC 13 includes a high-voltage input start terminal HV to which the voltage before being rectified in the diode bridge circuit 12 is applied through diodes D11 and D12 and a resistor R1. The power supply control IC 13 is configured to operate before the voltage is induced by the auxiliary winding wire Nb of at the start of power supply, based on the voltage from this high-voltage input start terminal HV when the power is input (just after a plug is inserted into an outlet).

In addition, in the present embodiment, a resistor Rs for current detection is connected between the ground point GND and a source terminal of the switching transistor SW, and moreover a resistor R2 is connected between a current detection terminal CS of the power supply control IC 13 and a connection node N1 between the switching transistor SW and the current detection resistor Rs. Furthermore, a capacitor C4 is connected between the ground point and the current detection terminal CS of the power supply control IC 13. The resistor R2 and the capacitor C4 form a low-pass filter.

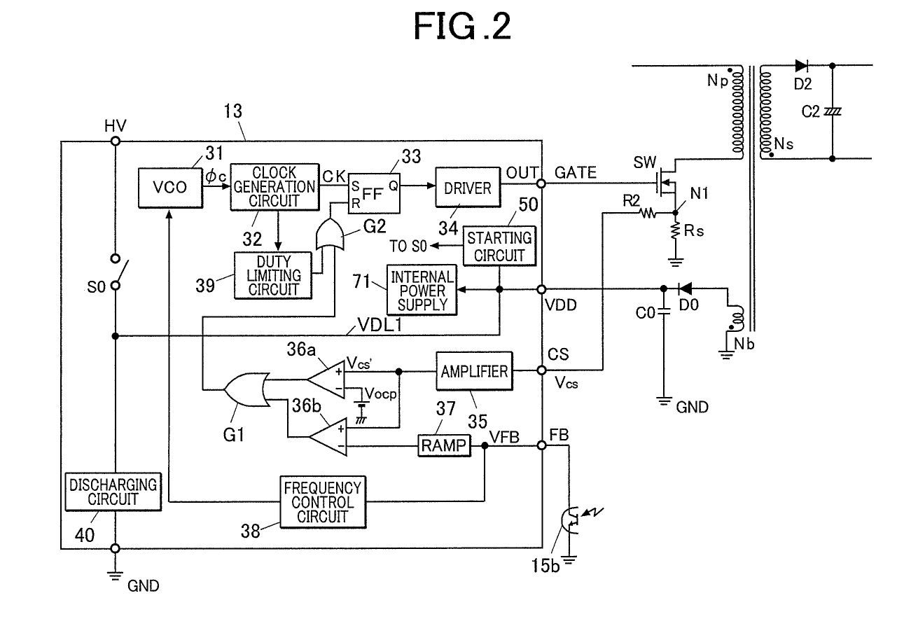

Next, with reference to FIG. 2, a specific structure example of the power supply control IC 13 is described.

As illustrated in FIG. 2, the power supply control IC 13 according to this embodiment includes: an oscillation circuit (VCO) 31 that oscillates at the frequency in accordance with the voltage VFB of the feedback terminal FB; a clock generation circuit 32 including a circuit like a one-shot pulse generation circuit that generates a clock signal CK for providing the timing to turn on the primary-side switching transistor SW on the basis of an oscillation signal Tc generated in the oscillation circuit 31; an RS/flip-flop 33 that is set by the clock signal CK; and a driver (a driving circuit) 34 that generates a driving pulse GATE of the switching transistor SW in accordance with the output of the flip-flop 33.

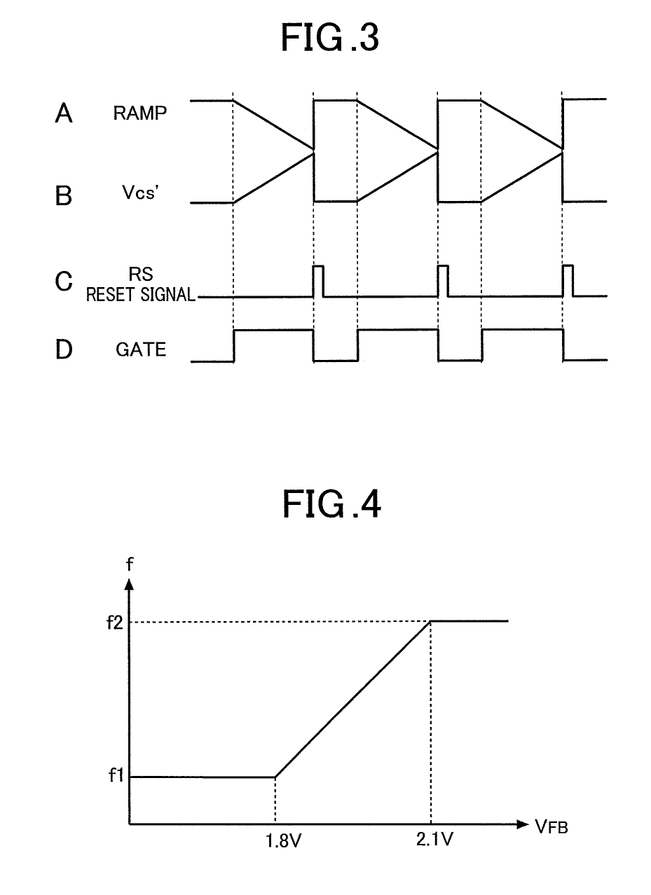

Moreover, the power supply control IC 13 includes: an amplifier 35 that amplifies the voltage Vcs input to the current detection terminal CS; a comparator 36a as a voltage comparison circuit that compares the voltage Vcs′ amplified by the amplifier 35 with a comparison voltage (threshold voltage) Vocp for monitoring the over-current state; a waveform generation circuit 37 that generates a voltage RAMP with a predetermined waveform as illustrated in FIG. 3A on the basis of the voltage VFB of the feedback terminal FB; a comparator 36b that compares a potential Vcs′ of a waveform as illustrated in FIG. 3B that is amplified by the amplifier 35 with a waveform RAMP generated by the waveform generation circuit 37; and an OR gate G1 that has logical disjunction of the outputs of the comparators 36a and 36b. In the power supply control IC 13 in the embodiment, the voltage RAMP in FIG. 3A is generated so as to decrease from the feedback voltage VFB with a constant inclination.

When the output RS of the OR gate G1 (see FIG. 3C) is input to a reset terminal of the flip-flop 33 through an OR gate G2, the timing to turn off the switching transistor SW is provided. Note that a pull-up resistor or a constant-current source is provided between the feedback terminal FB and an internal power supply voltage terminal, and the current flowing in the phototransistor 15b is converted into a voltage by the resistor. The waveform generation circuit 37 is provided in order to deal with the sub-harmonic oscillation, and another structure may alternatively be employed in which the voltage VFB is input to the comparator 36b directly or after being level-shifted. Further, a soft start circuit may be provided which generates a signal for resetting the flip-flop 33 so as to increase the primary-side current gradually to prevent the excess current from flowing in the primary-side winding wire when the power is supplied and the significant voltage VFB or Vcs is not generated in the feedback terminal FB or the current detection terminal CS.

Furthermore, the power supply control IC 13 in the embodiment includes a frequency control circuit 38 that changes the oscillation frequency, that is, the switching frequency of the oscillation circuit 31 on the basis of the voltage VFB of the feedback terminal FB in accordance with the characteristic as illustrated in FIG. 4. The frequency f1 in FIG. 4 is set to a value of, for example, 22 kHz and the frequency f2 is set to an arbitrary value in the range of, for example, 66 kHz to 100 kHz. The frequency control circuit 38 may be formed of a buffer such as a voltage follower and a clamp circuit. When the voltage of the feedback terminal FB is, for example, 1.8 V or less, the clamp circuit clamps the voltage to 0.7 V, and when the voltage is 2.1 V or more, the clamp circuit clamps the voltage thereof to 2.1 V. Although not shown, the oscillation circuit 31 includes an oscillator which is provided with a current source that supplies current in accordance with the voltage from the frequency control circuit 38 and whose oscillation frequency changes depending on the amount of current supplied from the current source.

The power supply control IC 13 in the embodiment includes a duty limiting circuit 39 that generates a maximum duty reset signal for limiting the duty (Ton/Tcycle) of the driving pulse GATE so that the duty does not exceed a prescribed maximum value (for example, 85% to 90%) on the basis of the clock signal CK output from the clock generation circuit 32. The maximum duty reset signal output from the duty limiting circuit 39 is supplied to the flip-flop 33 through the OR gate G2 and when the pulse has reached the maximum duty, the flip-flop 33 is reset at that time. Thus, the switching transistor SW is turned off immediately.

Furthermore, the power supply control IC 13 in the embodiment includes: a switch S0 which is formed of a high-voltage withstanding MOS transistor (field effect transistor) provided on the power supply line VDL1 between the high-voltage input start terminal HV and the power supply terminal VDD; a starting circuit (start circuit) 50 which is connected to the high-voltage input start terminal HV, and when the voltage is input to this terminal, turns on the switch S0 to start the IC; and a discharging circuit 40 which detects whether the plug of the AC power supply is removed from the outlet by monitoring the voltage of the high-voltage input start terminal HV and if it has been determined that the plug is removed, discharges the X capacitor Cx. Whether the plug is removed or not can be determined by, for example, detecting that the AC input voltage has not been lower than a predetermined value (for example, 75% of peak value) within a certain period of time (for example, 30 ms).

The switch S0 is turned on immediately after the alternating-current voltage is input to the high-voltage input start terminal HV, secures the voltage of the power supply terminal VDD by allowing the current flow in the capacitor C0 connected to the power supply terminal VDD from the high-voltage input start terminal HV, and when the voltage of the VDD terminal has become a predetermined value (for example, 21 V) or more, the switch S0 is turned off. The internal power supply circuit (regulator) 71 is connected to the power supply line Ll, when the switch S0 is turned on, the voltage of the power supply terminal VDD gradually rises, and thus, the internal power supply circuit 71 starts to operate and the internal power supply voltage is supplied to the internal circuit. When the power supply terminal VDD becomes a predetermined value (for example, 21V) or more, the internal circuit starts to operate and the driving pulse GATE is generated. Thus, after that, the voltage is supplied from the auxiliary winding wire Nb to the power supply terminal VDD.

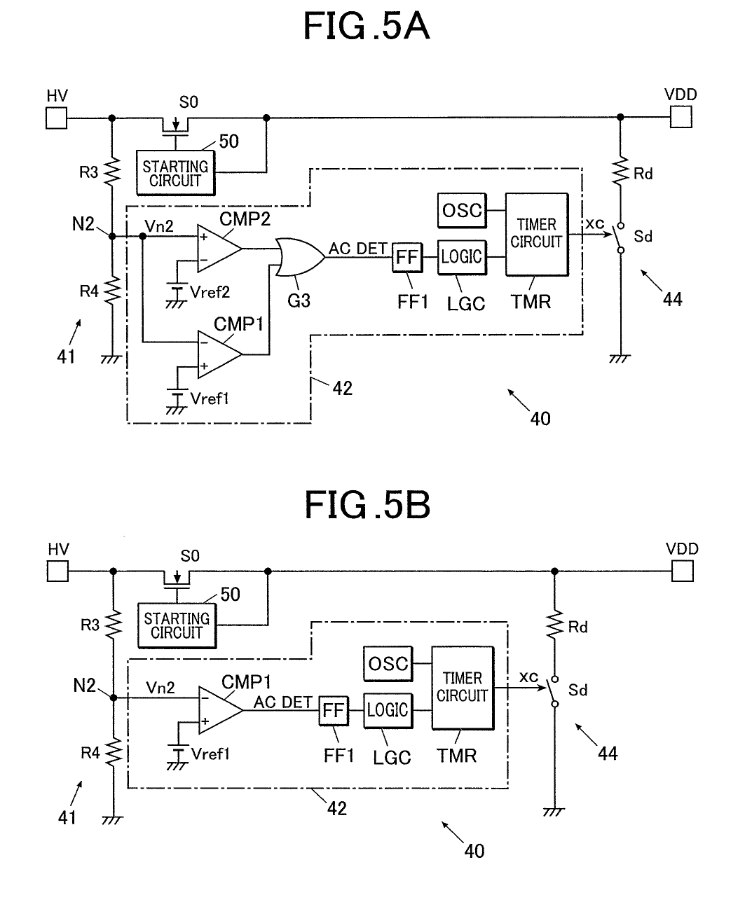

FIG. 5A illustrates a configuration example of the discharging circuit 40 in the power supply control IC illustrated in FIG. 2.

As illustrated in FIG. 5A, the discharging circuit 40 includes: an input voltage division circuit 41 including resistors R3 and R4 that are connected in series between the high-voltage input start terminal HV and the ground point; a discharging unit 44 including a resistor Rd and a switch Sd that are connected so as to be in series between the high-voltage switching element S0 and the ground point; and a discharging control circuit 42 which turns on and off the switch Sd. The resistors R3 and R4 are set to have a ratio (for example, 140:1) of resistance value such that the voltage of the high-voltage input start terminal HV is dropped to a voltage (for example, 6V) which is equal to or less than the withstanding voltage of the element forming the discharging circuit 40.

The discharging control circuit 42 includes comparators (voltage comparison circuits) CMP1, CMP2 which perform determination by comparing the voltage divided by the input voltage division circuit 41, that is, the potential Vn2 of the connection node N2 of the resistors R3 and R4 with predetermined reference voltages Vref1 and Vref2 (Vref1<Vref2) which are set in advance, an OR gate G3 which has a logical disjunction of output of the comparators CMP1 and CMP2, an oscillation circuit OSC and a timer circuit TMR which performs a time measuring operation by a clock signal from the oscillation circuit OSC, and the flip-flop FF1 set by the output of the OR gate G3 and a logic circuit LGC which generates a reset signal of the timer circuit TMR.

In the comparator CMP1, a reference voltage Vref1 is applied to a non-inverting input terminal (+), and when the potential Vn2 of the node N2 becomes lower than the Vref1, the output changes from a low level to a high level. In the voltage comparison circuit CMP2, a reference voltage Vref2 is applied to a non-inverting input terminal (−), and when the potential Vn2 of the node N2 becomes higher than the Vref2, the output changes from a low level to a high level.

The timer circuit TMR is provided for measuring the time when the potential Vn2 of the node N2 is not across the Vref1 and Vref2, that is, the time when the AC input voltage is not input to the high-voltage input start terminal HV. When it is determined that the measured time exceeds 30 ms, for example, the timer circuit TMR outputs a signal for turning on the switch S0 and the discharging switch Sd. The timer circuit TMR is reset to start measuring of 30 ms each time the potential Vn2 of the node N2 comes across the level of Vref1, Vref2.

Next, explanation will be made for how to determine the reference voltages Vref1 and Vref2 (Vref1<Vref2) and the operation of the discharging circuit 40.

The voltage level (effective value) of the commercial power supply (AC) in each country over the world can be generally covered by 100V, 110V, 115V, 120V, 127V, 220V, 230V and 240FV. In the embodiment, it is assumed that there are variations of ±15%, for example, in the AC input when the reference voltages Vref1 and Vref2 are determined.

Regarding the reference voltage Vref1 which is lower, if there is assumed a lower variation of −15% of 100V which is the lowest among the various commercial power supplies, for example, the peak value is 100×0.85×1.41=119.85V. Here, since the ratio of the resistors R3 and R4 is 140:1, the peak value inside the IC, that is, the peak value of the potential Vn2 of the connection node N2 is 0.85V. Then, if the reference voltage Vref1 is set to 0.8V lower than the peak value 0.85V, it is possible to detect whether the plug of AC power supply is removed from the outlet.

On the other hand, regarding the reference voltage Vref2 which is higher, if there is assumed an upper variation of +15% of 230V among the various commercial power supplies, for example, the peak value is 230×1.15×1.41=372.95V. Since the ratio of the resistors R3 and R4 is 140:1, in this case, the peak value of the potential Vn2 of the internal node N2 of IC is 2.645V.

In the embodiment, the reference voltage Vref2 was set to 2V corresponding to approximately 75% of the peak value, for example. Though any value of reference voltage Vref2 can be selected in the range such as 30 to 85% of the peak value, the voltage VHV of the high-voltage input start terminal HV is not sufficiently lowered in some cases depending on the configuration of power supply device and the characteristics of the elements which are used. Thus, by setting the reference voltage Vref2 to approximately 75% of the peak value of Vn2, detection can be surely performed regardless of the value of the input AC voltage. If Vref2 is approximately 85% of the peak value, there is a possibility that the above-mentioned lower variation of −15% is detected. Thus, the value around 75% is relatively desirable. However, it is not limited to this range.

Since the current consumption of the discharging circuit part of the X capacitor should be reduced limitlessly, if the device is not for worldwide but limited to a single country (for example, for Japan), the discharging circuit 40 may be configured by providing only a single reference voltage and a single comparator as shown in FIG. 5B. Accordingly, if the power supply control IC is for a single country, the consumption can be reduced more.

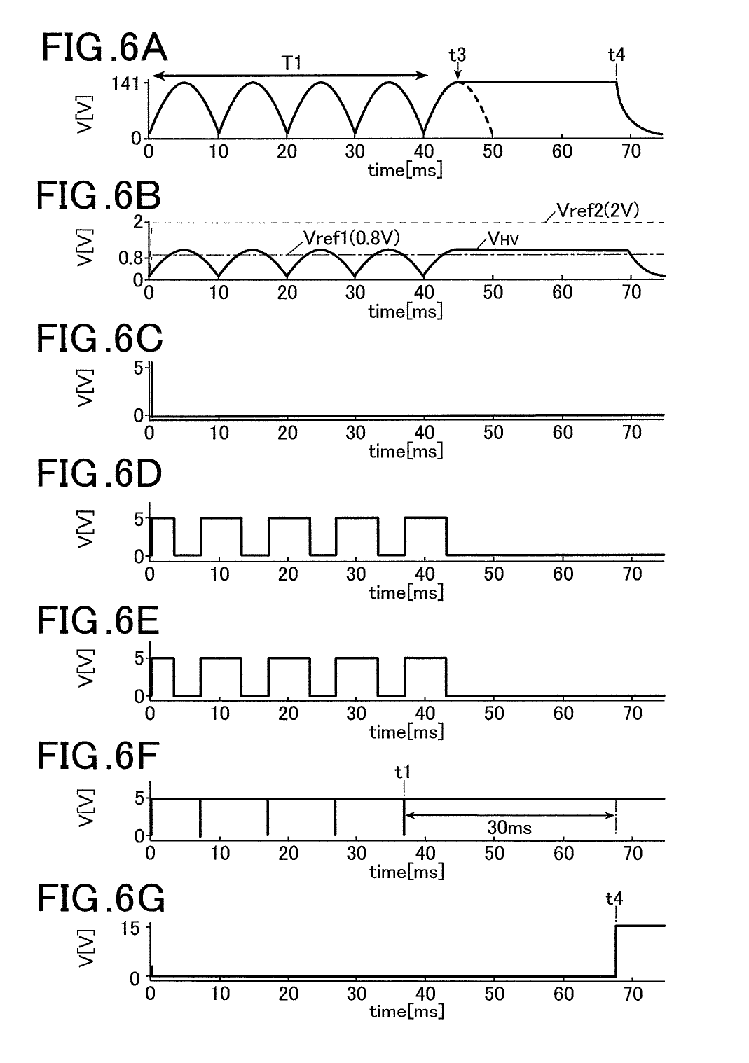

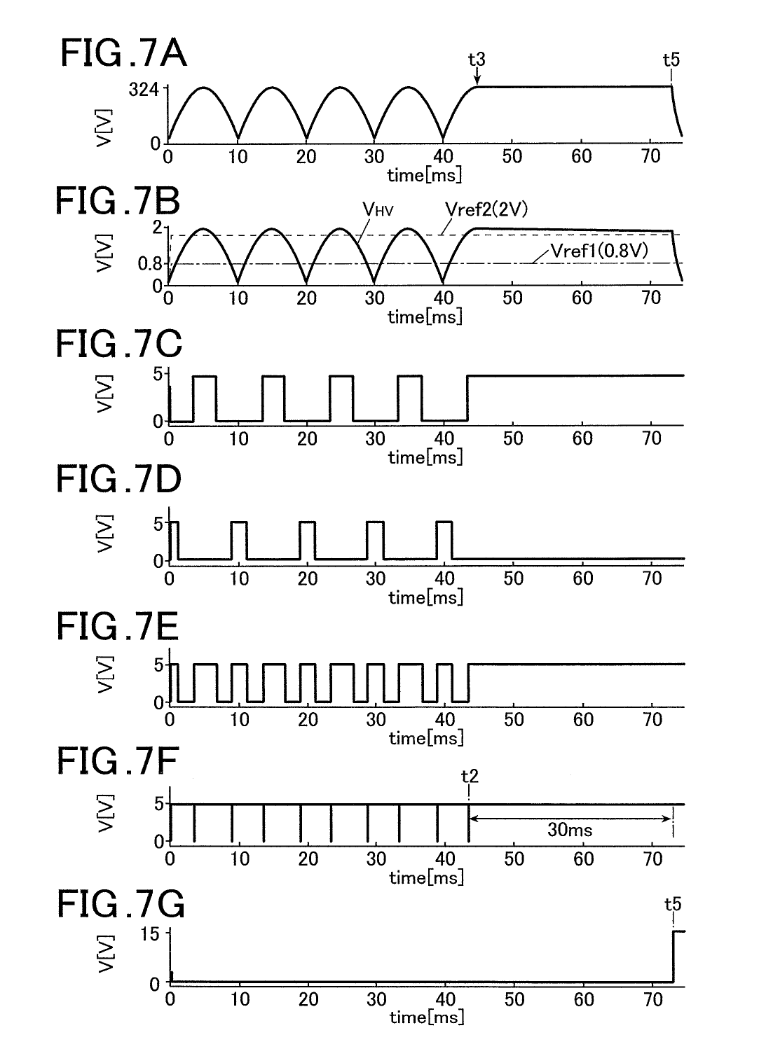

FIGS. 6A to 7G show the operation timings by the discharging circuit 40 shown in FIG. 5A. Among them, FIGS. 6A to 6G show a case of using the power supply device of AC 100V type, and FIGS. 7A to 7G show a case of using the power supply device of AC 230V type. In FIGS. 6A to 7G, each of FIGS. 6A and 7A shows a waveform of the voltage VHV of the high-voltage input start terminal HV, and each of FIGS. 6B and 7B shows a waveform of the voltage Vn2 of the node N2 dividing the above voltage by the resistors R3 and R4, with one-dot chain line representing the value of Vref1 and broken line representing Vref2. Each of FIGS. 6C and 7C shows an output waveform of the comparator CMP2, each of FIGS. 6D and 7D shows an output waveform of the comparator CMP1, each of FIGS. 6E and 7E shows an output waveform of the OR gate G3, each of FIGS. 6F and 7F shows a reset timing of the timer circuit TMR, and each of FIGS. 6G and 7G shows the output waveform of the timer circuit TMR, that is, the control voltage signal of the discharging switch Sd. The t3 indicates the timing when the plug was removed from the outlet.

As shown in FIGS. 6A to 7G, the pulse is output from the comparators CPM1 and CMP 2 with a cycle corresponding to the cycle of voltage waveform of the high-voltage input start terminal HV during a normal period T1. When the plug is removed at the timing t3, the pulse is not output from the comparators CMP1 and CMP2. Then, at the time points t4 and t5 when 30 ms elapsed from the rising time points t1 and t2 of the last pulse, the output XC of the timer circuit TMR changes to a high level to turn on the discharging switch Sd and perform discharging of the X capacitor, and the voltage VHV of the high-voltage input start terminal HV promptly decreases.

As described above, in the power supply control IC provided with the discharging circuit 40 shown in FIG. 5A, in a case where the AC input is interrupted, it is possible to promptly discharge the residual charges in the X capacitor, and the switch S0 for power supply is turned off by the starting circuit 50 in the normal operation state. Thus, it is possible to eliminate the power loss by the discharging resistor Rd. Since the removal of the plug can be detected by the voltage comparison circuits, it is possible to reduce the power consumption compared to conventional devices using a peak holding circuit, and achieve the worldwide power supply control IC which can handle the commercial power supplies (AC) in each country over the world since two voltage comparison circuits are provided.

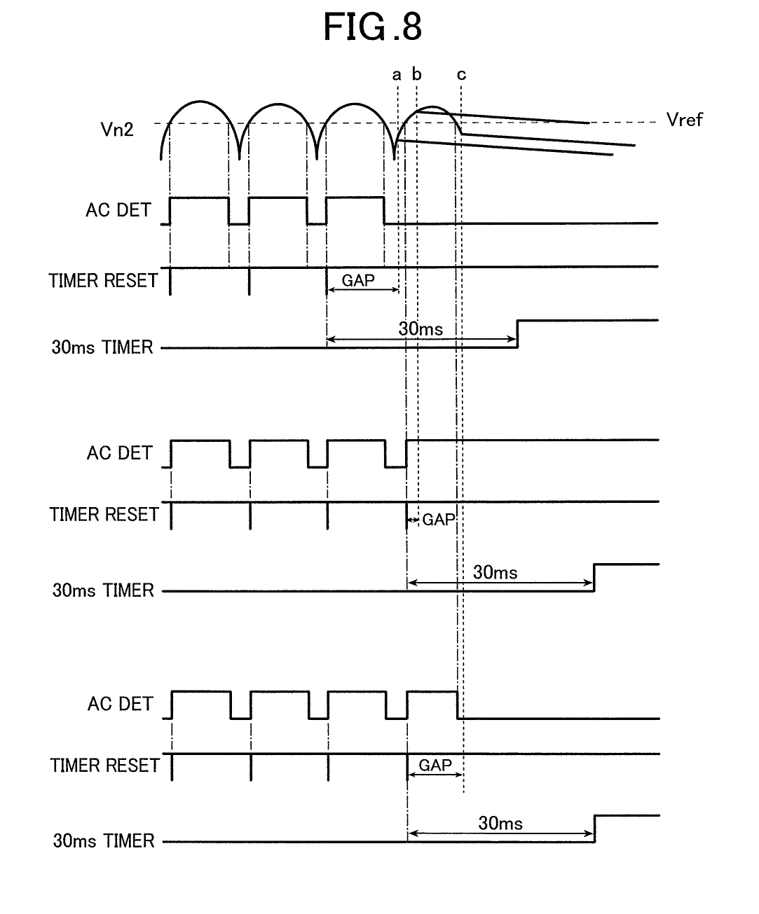

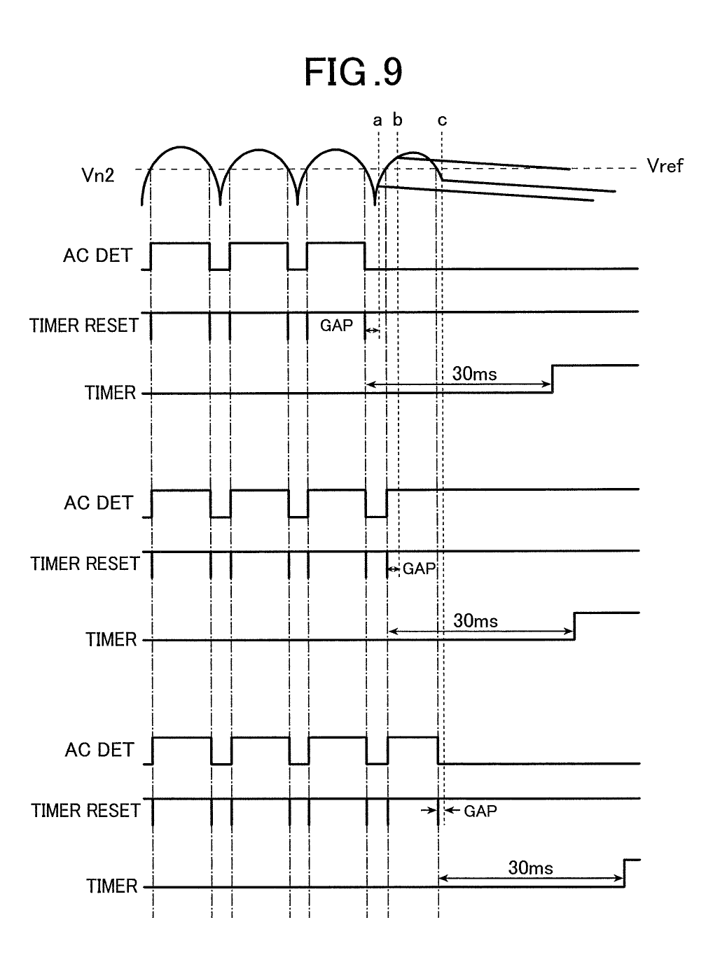

As mentioned above, in the discharging circuit 40 shown in FIG. 5A, the timer circuit TMR is configured to be reset at the rising timing of OR gate G3 output. In this case, a substantial measuring time of the timer circuit TMR is sometimes changed (earlier or later than 30 ms) according to the timing of the plug removal in the waveform of AC input. This is because the time measuring of the timer circuit TMR starts from the point of crossing the reference voltage when Vn2 rises. Specifically, as shown in FIGS. 8 and 9, when the plug removal occurs at any timing indicated by the codes a, b and c, the timing to reset the timer circuit TMR is different. The measured time which is closest to 30 ms is obtained when the plug removal occurs at the timing immediately after the crossing of reference voltage when Vn2 rises as shown by the code b. The measured time is shorter when the plug removal occurs at the timings shown by the codes a and c.

In order to reduce such deficiencies, there may be used a timer circuit TMR which is reset at both of the timings of input rising edge and lowering edge. FIG. 9 shows the operation timing by the discharging circuit 40 in such a case. FIG. 9 shows that even if the plug removal occurs at the timings shown by the codes a and c, the measured time merely becomes slightly shorter than 30 ms, and does not become extremely short.

In the search regarding the commercial power supplies (AC) in each country over the world, the present inventor found a country which adopts 127V as a voltage level (effective value). In a case of this power supply, the peak voltage is approximately 179V, and the effective voltage of upper variation of 15% is approximately 146V. At this time, the peak value of potential Vn2 of the node N2 inside the IC is approximately 1.46V, and for example, the reference voltage Vref1 of 0.8V is approximately 55% of 1.46V. Thus, there are cases where the lower limit level of Vn2 is 60% or more of the peak value thereof depending on the design (configuration) of the power supply device and the elements which are used. Thus, it was found that there is a possibility of wrong detection. Accordingly, in order to provide a power supply control IC which can also be used in such a country, it is desirable to increase the number of the comparators (voltage comparison circuits).

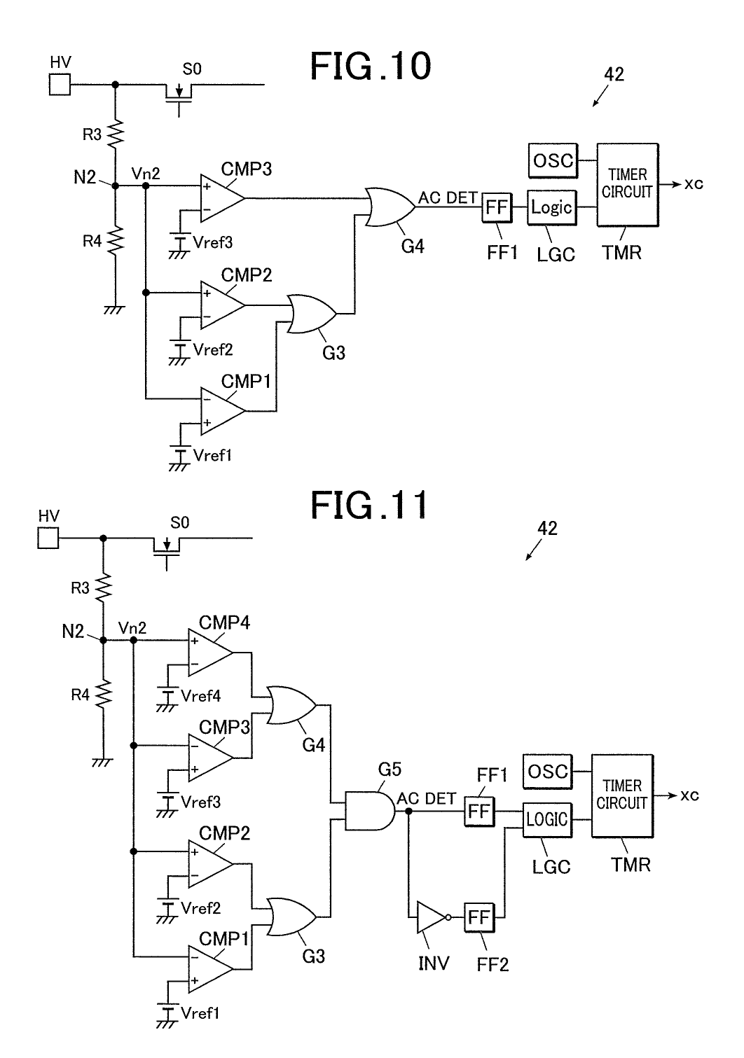

FIG. 10 shows a second example of the discharging circuit 40.

The discharging circuit 40 shown in FIG. 10 is provided with three comparators (voltage comparison circuits) using respective different reference voltages Vref1 to Vref3 as comparison voltage, and provided with OR gates G3 and G4 which have logical disjunction of output of the comparators CMP1 to CMP3 to generate a reset signal of the timer circuit TMR. In the example, for example, 0.8V is selected as the reference voltage Vref1 to be applied to the inverting input terminal of the comparator CMP1, 1.2V is selected as the reference voltage Vref2 to be applied to the inverting input terminal of the comparator CMP2, and 1.8V is selected as the reference voltage Vref3 to be applied to the non-inverting input terminal of the comparator CMP3.

FIG. 11 shows a third example of the discharging circuit 40.

The discharging circuit 40 shown in FIG. 11 is provided with four comparators (voltage comparison circuits) using respective different reference voltages Vref1 to Vref4 as the comparison voltage, and provided with OR gate G3 which has a logical disjunction of output of the comparators CMP1 and CMP2, OR gate G4 which has a logical disjunction of output of the comparators CMP3 and CMP4, AND gate G5 which has a logical conjunction of output of the OR gates G3 and G4, an inverter INV which inverts the output of AND gate G5, flip-flops FF1 and FF2 which latch the output of the AND gate G5 and the inverter INV, and a logical circuit LGC which generates a reset signal of the timer circuit TMR.

In this example, for example, 0.8V is selected as the reference voltage Vref1 to be applied to the inverting input terminal of the comparator CMP1, 1.2V is selected as the reference voltage Vref2 to be applied to the non-inverting input terminal of the comparator CMP2, 1.6V is selected as the reference voltage Vref3 to be applied to the inverting input terminal of the comparator CMP3, and 2.0V is selected as the reference voltage Vref4 to be applied to the non-inverting input terminal of the comparator CMP4.

In a case of a country which adopts 240V as the commercial power supply (AC), the upper variation of the AC input +15% is 276V, the peak voltage is 389V, and the peak value of the potential Vn2 of the node N2 is 2.76V. Thus, for example, if the reference voltage Vref3 is 1.8V and Vref2 is 1.2V in the example of FIG. 10, Vref3 corresponds to 65% and Vref2 corresponds to 43.5% with respect to 2.76V.

Thus, the discharging circuit 40 using three comparators shown in FIG. 10 performs wrong detection in a case where the lower limit level of Vn2 is merely around 50% of the peak value thereof (potential between Vref3 and Vref2), for example, depending on the design (configuration) of the power supply device and the elements which are used. With respect to this, by using the discharging circuit 40 using four comparators as shown in FIG. 11, it is possible to more surely prevent the wrong detection.

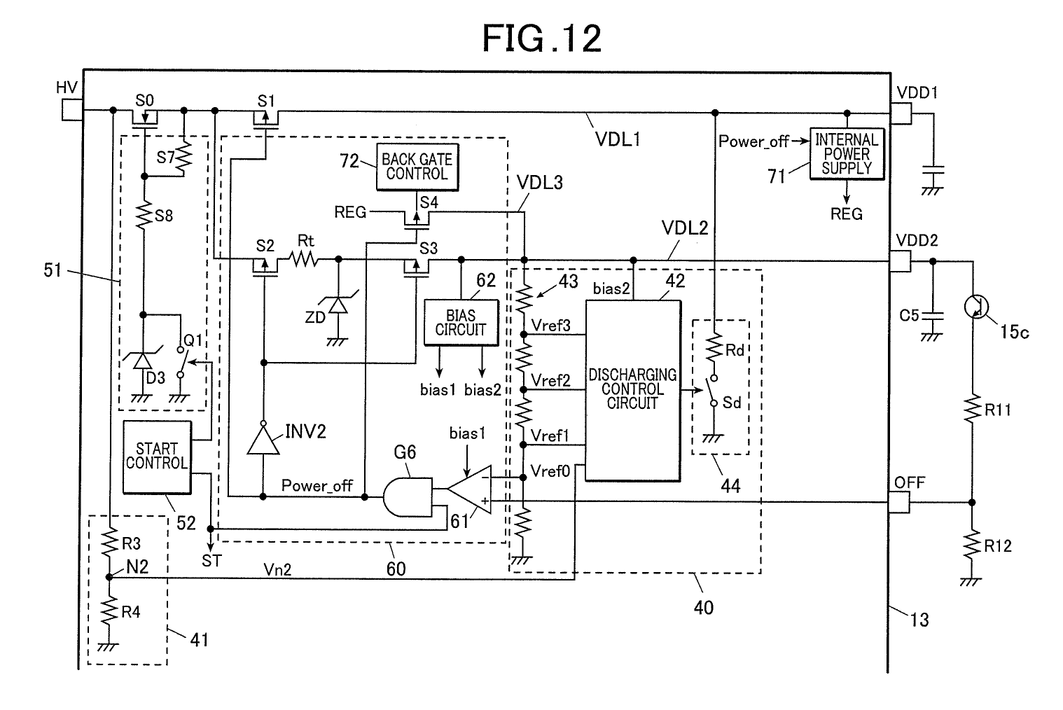

FIG. 12 shows a second embodiment of the power supply control IC using the discharging circuit 40 of FIG. 10. In this embodiment, an off mode control circuit 60 is provided in order to reduce the power consumption of the IC, and the discharging circuit 40 can be operated even when the off mode control circuit 60 is operated. In FIG. 12, the discharging control circuit 42 is shown in a simplified manner. The power supply terminal VDD1 corresponds to the power supply terminal VDD in FIG. 2. There is also provided a power supply terminal VDD2 to which the phototransistor 15c is connected.

As shown in FIG. 12, the discharging circuit 40 includes a discharging unit 44 which is formed of a resistor Rd and a discharging switch Sd connected in series with the high-voltage switching element S0 and the switch S1 between the high-voltage input start terminal HV and the ground point GND, a discharging control circuit 42 which has the above configuration and detects the potential of AC input to the high-voltage input start terminal HV to control on/off of the discharging switch Sd, and a resistance voltage division circuit 43 which generates the reference voltages Vref1 to Vref3 used by the discharging control circuit 42. The resistance voltage division circuit 43 also generates the reference voltage Vref0 which is used by the off mode control circuit 60.

The off mode control circuit 60 includes an off detection comparator 61 which detects whether the command signal of power off is input to the phototransistor 15c from a microcomputer or the like by comparing the reference voltage generated by the resistance voltage division circuit 43 with the voltage of the terminal OFF, and a bias circuit 62 which generates current Ibias1 for operating the comparator 61. The bias circuit 62 also generates the operation current Ibias2 of the comparator in the discharging control circuit 42.

Specifically, the bias circuit 62 includes a constant voltage circuit which generates a constant voltage not having a temperature characteristic, and a constant current source (constant current transistor) making current flow proportional to the constant voltage from the constant voltage circuit. The operation current flows in each comparator by current mirror connection between the constant current transistor of the bias circuit 62 with the comparator in the discharging circuit 40 and the current transistor of the off detection comparator 61.

As shown in FIG. 12, the power supply line VDL1 is connected between the high-input start terminal HV and the power supply terminal VDD1, a switch S0 formed of a high voltage withstanding transistor (field-effect transistor) controlled by the starting circuit 50 is provided on the power supply line VDL1, and the switch S0 is turned on immediately after an alternating voltage is input to the high-voltage input start terminal HV and the switch S0 is turned off when the power supply terminal VDD1 has a voltage of a predetermined value (for example, 21V) or more. An internal power supply circuit (regulator) 71 is connected to the power supply line Li, and when the switch S0 is turned on, the internal power supply circuit 71 starts to operate and supplies the internal power supply voltage REG to the internal circuit. Then, the internal circuit operates to generate a drive pulse GATE, thereafter, the voltage from the auxiliary winding wire is supplied to the power supply terminal VDD1, and the internal circuit operates with the voltage from the power supply terminal VDD1 while maintaining the switch S0 be turned off.

The gate terminal as the control terminal of the switch S0 is connected to a switch control circuit 51 which includes resistors R7, R8 and an enhancement type MOS transistor Q1 which are connected in series between a source terminal of the switch S0 and the ground point; and a Zener diode D3 for clamping which is provided in parallel with the transistor Q1. By turning on the transistor Q1, a negative voltage which is sufficient with respect to the source voltage (threshold voltage of the high voltage switch S0 or more) is applied to the gate terminal of the switch S0 as the depression type MOS transistor, so that the channel can be set to the non-conductive state (state in which the drain current does not flow). When the transistor Q1 is turned off, the switch S0 becomes to be in an on state by the voltage level of the power supply terminal VDD1.

The signal from the start control circuit 52 is applied to the gate terminal of the MOS transistor Q1, and by turning off Q1 when the discharging switch Sd is turned on, the MOS transistor as the switch S0 for power supply is turned on. The start control circuit 52 incorporates the voltage comparator, and turns on the switch S0 when the voltage of the power supply terminal VDD1 is, for example, 6.5 V or less, and turns off the switch S0 when the voltage of the VDD1 is, for example, 21 V or more. In this specification, the combination of the switch control circuit 51 and the start control circuit 52 corresponds to the starting circuit 50.

As shown in FIG. 12, a switch S1 is provided in series with the switch S0 on the power supply line VDL1 between the high-voltage input start terminal HV and the power supply terminal VDD1, and MOS transistors S2 and S3 as switching element are provided in series on the power supply line VDL2 connecting the connection node between S0 and S1 with the power supply terminal VDD2. To the power supply line VDL2, the discharging control circuit 42 and the resistance voltage division circuit 43 and the power supply terminal of the off detection comparator 61 are connected. A resistance element Rt which limits the current flowing from the high-voltage input start terminal HV is connected between the MOS transistors S2 and S3 on the power supply line VDL2, and a Zener diode ZD having a function of clamping the voltage of the power supply terminal VDD2 is connected between the power supply line VDL2 and the ground point.

Furthermore, a power supply line VDL3 which supplies the internal power supply voltage REG from the internal power supply circuit 71 is connected to the power supply line VDL2, and an MOS transistor S4 as a switching element is provided on the power supply line VDL3. As for the MOS transistor S4 and the switch S0 on the power supply line VDL1, the on/off is controlled by the output signal of the AND gate G6 which has a logical conjunction between the output of the off detection comparator 61 and the signal ST output from the start control circuit 52. As for the MOS transistors S2 and S3 on the power supply line VDL2, on/off is controlled by the signal obtained by inverting the output of AND gate G6 with the inverter INV2.

The signal ST output from the start control circuit 52 is a signal for making all the circuits in the IC into an operating state by the signal ST becoming a high level when the voltage of the power supply terminal VDD1 reaches 21V, for example. The on/off of the switches S1 to S4 is controlled by the signal (output of the AND gate G6) which has a logical conjunction between the signal ST and the output of the off detection comparator 61. Thereby, it is possible to start the IC at the time of AC plug-in regardless of the state of the terminal OFF as the command input terminal from outside. Specifically, the shift to the off mode with the switch S1 being turned off and the switch S2 being turned on is not performed even when the command input terminal (terminal OFF) changes from a low level to a high level and the output of the off detection comparator 61 changes to a high level due to the influence of noise or the like or in a case where the phototransistor 15c receives a power off signal from a microcomputer or the like on the secondary side and operates wrongly for some reason immediately after the plug-in from a state in which the plug is removed and there is no AC input to the high-voltage input start terminal HV. Since the switch S1 is turned on at the time of AC plug-in, it is possible to surely start the IC.

Furthermore, in the embodiment, for a case where the potential of the power supply terminal VDD2 becomes higher than the internal power supply voltage REG, there is provided a back gate control circuit 72 for preventing the flow of current in the reverse direction through the parasitic diode between the source and drain of the transistor S4 and the semiconductor substrate in parallel with the MOS transistor S4 on the power supply line VDL3.

Next, the operation of the off mode control circuit 60 will be described.

At the time of normal operation, output of the off detection comparator 61 which receives the internal power supply voltage from the internal power supply circuit 71 and operates is at a low level, the MOS transistors S2 and S3 on the power supply line VDL2 are in an off state, and the MOS transistor S4 on the power supply line VDL3 is in an on state. The discharging control circuit 42, the resistance voltage division circuit 43 and the off detection comparator 61 operate by the internal power supply voltage REG from the internal power supply circuit 71.

At this time, when a plug which is the tip of the power supply cord is removed from the outlet, the AC input to the high-voltage input start terminal HV is not performed, and when a predetermined time (for example, 30 ms) elapsed, the discharging switch Sd is turned on and the discharging can be performed in the X capacitor Cx.

In such a way, by promptly discharging the residual charges in the X capacitor Cx (see FIG. 1) when a plug is removed, it is not necessary to provide a resistor for discharging connected in parallel with the X capacitor Cx. Thus, it is possible to avoid increase in standby power at the time of non-load and at the time of standby in the discharging resistor.

On the other hand, when the phototransistor 15c receives the power off signal from the microcomputer or the like on the secondary side, the output of the off detection comparator 61 changes to a high level into the off mode, the operation of the internal power supply circuit 71 is stopped and the MOS transistors S2 and S3 on the power supply line VDL2 are turned on. Then, current flows in the Zener diode ZD via S2 and S3 from the high-voltage input start terminal HV, the power supply line VDL2 is clamped to the Zener voltage, and this power supply guarantees the operations of the discharging circuit 40 for the X capacitor and the bias circuit 62 and the off detection comparator 61 which are circuits which perform minimum operation at the time of standby.

The stop of operation of the internal power supply circuit 71 stops the operation of the circuit other than these circuits, and the power consumption of IC is reduced. Specifically, it is possible to suppress the power consumption at the time of AC 100V input in this off mode to approximately 3 mW.

The operation of the discharging circuit 40 is guaranteed by supplying the bias current Ibias2 from the bias circuit 62 and the power supply of power supply terminal VDD2 to the discharging circuit 40. Thus, even when the plug which is the tip of the power supply cord is removed from the outlet during the off mode, when 30 ms elapses after end of the AC input to the high-voltage input start terminal HV, the discharge switch Sd is turned on to allow discharging in the X capacitor.

When supply of the power off signal to the phototransistor 15c ends, the output of the off detection comparator 61 changes to a low level, the operation stop of the internal power supply circuit 71 is released, the MOS transistors S2 and S3 on the power supply line VDL2 are turned off, and the switch S1 on the power supply line VDL1 is turned on (at this time, the VDD1 becomes 6.5V or less by the operation stop of IC, and the S0 is turned on by the starting circuit 50). Thus, the current flows in the capacitor C0 of the power supply terminal VDD1 from the high-voltage input start terminal HV, the potential of the power supply line VDL1 rises to make the internal power supply circuit 71 start to operate, and the internal circuit operates to start the switching control. When supply of the power off signal ends, the MOS transistor S4 on the power supply line VDL3 is turned on, the internal power supply voltage LEG from the internal power supply circuit 71 is supplied to the bias circuit 62 and the resistance voltage division circuit 43, and the off detection comparator 61 and the comparators in the discharging control circuit 42 operate by the internal power supply voltage.

### Modification Example

In the power supply control IC in the embodiment, the off mode is maintained by continuing to receive the off mode signal from the microcomputer or the like on the secondary side with the photo transistor 15c. However, there may be provided a toggle flip-flop (T-FF) which inverts the output at each time of pulse input to the back part of the off detection comparator 61, so that shift to the off mode and return from the off mode to the normal mode are performed by receiving the off mode signal of one shot from the microcomputer or the like on the secondary side.

In a case where the Zener voltage of Zener diode ZD is a potential which is different from the internal power supply voltage generated by the internal power supply circuit 71, at the time of shift to the off mode, each of the reference voltages of the off detection comparator 61 and the comparators inside the discharging control circuit 42 generated in the resistance voltage division circuit 43 shifts from the potential of the normal mode. Thus, there may be provided a switching element in parallel with any resistor forming the resistance voltage division circuit 43 so that the on/off state of the switching element is switched according to the mode and the reference voltages generated by the resistance voltage division circuit 43 become nearly same.

Though the present invention has been specifically described on the basis of the embodiments, the present invention is not limited to the embodiments. For example, in the embodiment (FIG. 12), the reference voltages Vref1 to Vref3 are formed by the resistance voltage division circuit 43. However, the reference voltages Vref1 to Vref3 may be generated by the reference voltage generation circuit or the like.

In the embodiment, the switching transistor SW making current flow intermittently in the primary-side winding wire of the transformer is another element separate from the power supply control IC 13. However, this switching transistor SW may be taken into the power supply control IC 13 to be a single semiconductor integrated circuit.

Furthermore, in the embodiment, the present invention has been described for a case of applying the present invention to the power supply control IC forming a flyback AC-DC converter. However, the present invention can be applied to the power supply control IC forming a forward AC-DC converter.

The entire disclosure of Japanese Patent Application No. 2017-168344 filed on Sep. 1, 2017 including description, claims, drawings, and abstract are incorporated herein by reference in its entirety.

What is claimed is:

1. A semiconductor device for power supply control which generates and outputs a driving pulse for performing control to turn on or off a switching element which intermittently makes current flow to a primary-side winding wire of a transformer for voltage conversion, by inputting voltage in proportion to current flowing in the primary-side winding wire of the transformer and an output voltage detection signal from a secondary side of the transformer, the semiconductor device comprising:
a high-voltage input start terminal to which alternating-current voltage of AC input or voltage rectified in a diode bridge is input;
a plurality of voltage comparison circuits to which voltage obtained by dividing voltage input to the high-voltage input start terminal is input, and which compare the input voltage with any of a plurality of reference voltages that are different from each other;
a timer circuit which starts to measure a predetermined time at a timing of rising and/or falling of output of the plurality of voltage comparison circuits; and
a discharging unit which is provided between the high-voltage input start terminal and a ground point, wherein
when the timer circuit measures the predetermined time, the discharging unit is made conductive.

2. The semiconductor device for power supply control according to claim 1, comprising:
a high-voltage switching element which is connected to the high-voltage input start terminal;
a first power supply terminal to which voltage induced by an auxiliary winding wire of the transformer is input;
a second power supply terminal to which a receiving element that receives a command signal from outside is connected;
a command input terminal to which a current-voltage converting unit that is connected in series with the receiving element and converts current flowing in the receiving element into voltage is connected;
a first power supply line and a first switching unit which is provided on the first power supply line, the first power supply line being connected between the high-voltage input start terminal and the first power supply terminal via the high-voltage switching element;
a second power supply line and a second switching unit which is provided on the second power supply line, the second power supply line being connected between the high-voltage input start terminal and the second power supply terminal via the high-voltage switching element;
a Zener diode which is connected between the second power supply line and the ground point;
a bias circuit which is connected to the second power supply line; and
a detection circuit which is connected to the bias circuit and compares voltage of the command input terminal with a predetermined voltage value to detect whether input is performed or not, wherein
under a predetermined condition, the first switching unit is turned on and the second witching unit is turned off when the detection circuit detects that the voltage of the command input terminal is lower than the predetermined voltage value, and
the first switching unit is turned off and the second witching unit is turned on when the detection circuit detects that the voltage of the command input terminal is higher than the predetermined voltage value.

3. The semiconductor device for power supply control according to claim 2, comprising:
an internal power supply circuit which is connected to the first power supply line;
a third switching unit which is provided between the Zener diode and the second power supply terminal; and
a fourth switching unit for supplying an internal voltage generated by the internal power supply circuit to the second power supply line, wherein
the third switching unit is turned off and the fourth switching unit is turned on when the detection circuit detects that the voltage of the command input terminal is lower than the predetermined voltage value, and the third switching unit is turned on and the fourth witching unit is turned off when the detection circuit detects that the voltage of the command input terminal is higher than the predetermined voltage value.

4. The semiconductor device for power supply control according to claim 3, wherein operation of the internal power supply circuit is stopped based on an output signal of the detection circuit when the detection circuit detects that the voltage of the command input terminal is higher than the predetermined voltage value.

5. The semiconductor device for power supply control according to claim 2, wherein a fourth switching unit is formed by a field effect transistor, and a back gate control circuit is provided so as to correspond to the fourth switching unit, the back gate control circuit being for preventing reverse current flow from the second power supply terminal to an internal power supply circuit on a third power supply line when Zener voltage is higher than an internal voltage.

6. A power supply device comprising:
the semiconductor device for power supply control according to claim 1;
a transformer for voltage conversion having a primary side to which alternating voltage of AC input or voltage rectified in a diode bridge is input;
a switching element which is connected to a primary-side winding wire of the transformer and controlled by the semiconductor device for power supply control; and
a rectifying circuit which is provided on a secondary side of the transformer for voltage conversion, wherein
an X capacitor is connected between input terminals of the AC input, a rectifying element is connected between a terminal of the X capacitor and the high-voltage input start terminal, and when the discharging unit is made conductive, discharging current flows via the rectifying element, the high-voltage input start terminal and a high-voltage switching element.

7. A discharging method for an X capacitor in a power supply device that includes: a transformer for voltage conversion having a primary side to which alternating voltage of AC input or voltage rectified in a diode bridge is input; a switching element which is connected to a primary-side winding wire of the transformer for voltage conversion and which is for intermittently making current flow in the primary-side winding wire of the transformer; a signal generation circuit which generates a signal for performing control to turn on or off the switching element; an X capacitor which is connected between input terminals of the AC input; a discharging unit which is connected via a rectifying element between a terminal of the X capacitor and a ground point; and a rectifying circuit which is provided on a secondary side of the transformer for voltage conversion, the discharging method comprising:
a first step of comparing voltage obtained by dividing voltage supplied via the rectifying element with a predetermined reference voltage;
a second step of starting time measuring operation in response to detection that the voltage obtained by voltage division becomes lower than the predetermined reference voltage; and
a third step of making discharging current flow via the rectifying element by making the discharging unit conductive when a predetermined time is measured by the second step.
